(19) United States
(12) Patent Application Publication
(10) Pub. No.: US 2023/0252764 A1
(43) Pub. Date: Aug. 10, 2023

(54) SYSTEMS AND METHODS FOR GENERATING IMAGES FOR TRAINING ARTIFICIAL INTELLIGENCE SYSTEMS

(71) Applicant: Omni Consumer Products, LLC, Addison, TX (US)

(72) Inventor: Marc A. Gilpin, Richardson, TX (US)

(73) Assignee: Omni Consumer Products, LLC, Addison, TX (US)

(21) Appl. No.: 18/004,512

(22) PCT Filed: Jul. 6, 2021
(86) PCT No.: PCT/US2021/040549

§ 371 Date: Jan. 6, 2023

Related U.S. Application Data
(60) Provisional application No. 63/049,072, filed on Jul. 7, 2020.

(51) Int. Cl. G06V 10/774; G06V 20/17; G06T 11/00; G06T 11/60

(52) U.S. Cl. CPC G06V 10/774; G06T 11/001; G06T 11/60; G06V 20/17

(57) ABSTRACT

An image training system comprises a memory, and a processor configured to: simulate a physical environment containing an object, the simulated physical environment corresponding to a real physical environment in which the object is disposed. The processor is configured to simulate a camera lens view of the physical environment, which corresponds to a view of the real physical environment that would be captured by one or more image capture devices. The processor is configured to render the camera lens view to obtain a photorealistic view of the physical environment. The processor generates a plurality of simulated images of the physical environment, annotate the plurality of simulated images so as to generate a plurality of annotated images, and generate a data package containing the plurality of annotated images. The plurality of annotated images are configured to train an artificial intelligence (AI) system associated with the one or more image capture devices.

### CROSS-REFERENCE TO RELATED APPLICATIONS

The disclosure claims priority to and benefit of U.S. Provisional Appl. No. 63/049,072, filed, Jul. 7, 2020, the entire disclosure of which is hereby incorporated by reference herein.

### FIELD OF THE INVENTION

The disclosure relates to systems and methods for replicating reality in a computer graphic environment, i.e. 2D and/or 3D graphic, to train computer systems and to be used in artificial intelligence (AI) and machine learning.

### BACKGROUND

Machine learning or artificial intelligence systems that are associated with machine vision systems generally have to be trained on the images taken by the machine vision system. This training enables the artificial intelligence to identify features or objects located in the images taken by the particular machine vision system. A plurality of images such as 50-100 images of a particular physical environment may be needed to sufficiently train the AI system such that the AI system can reliably recognize features (e.g., physical objects) included in images or video that is captured by the machine vision system of that particular physical environment. Conventionally, to train such AI systems a user takes a plurality of images of the physical environment, for example, from different angles, in different lighting, etc., which can then be used to train the AI system. The image taking process is however, a tedious process and it can take several hours or even longer to obtain a sufficient number of images that can be used to properly train the AI system to recognize physical objects such that the AI system can reliably recognize objects or features in images taken by the machine vision system during operation.

### SUMMARY

Embodiments described herein generally relate to systems and methods for generating simulated images for training machine learning or AI systems. Particularly, systems and methods described herein relate to an image generation system that is configured to generate a plurality of simulated images that correspond to real images of a physical environment containing an object that would be captured by a machine vision system associated with an AI. The plurality of simulated images are used to train the AI system in lieu of real training images of the physical environment.

In some embodiments, an image generation system, comprises: a memory, and a processor. The processor is configured to simulate a physical environment containing an object, the simulated physical environment corresponding to a real physical environment in which the object is disposed. The processor is configured to simulate a camera lens view of the physical environment, the simulated camera lens view corresponding to a view of the real physical environment that would be captured by one or more image capture devices. The processor is configured to render the camera lens view to obtain a photorealistic view of the physical environment, and generate a plurality of simulated images of the physical environment. The processor is configured to annotate the plurality of simulated images so as to generate a plurality of annotated images. The processor is configured to generate a data package containing the plurality of annotated images, the plurality of annotated images configured to train an AI system associated with the one or more image capture devices.

In some embodiments, the processor simulates the physical environment by at least one of: modelling the object and the physical environment; texturing the modeled object and physical environment; and illuminating the modeled object and physical environment corresponding to an illumination of the real physical environment. In some embodiments, each of the plurality of simulated images are different from each other. In some embodiments, each of the plurality of simulated images is simulated at a different angle from another one of the plurality of simulated images.

In some embodiments, the training of the AI system associated with the one or more image capture devices includes using the plurality of annotated images in conjunction with an automated model to train the AI system associated with one or more image capture devices to identify the objects rendered in the simulated scenes in real life.

In some embodiments, the processor of the image generation system utilizes communication between the one or more image capture devices to map a retail facility in order to identify a location of one or more objects within the retail facility.

In some embodiments, a machine learning system, comprises: the image generation system as described above; and the AI system. The AI system comprises: an AI system memory; and an AI system processor configured to: receive the data package from the image generation system, and use the plurality of annotated images to train for identifying the object located in the real physical environment based on real images captured by the one or more image.

In some embodiments, the machine learning system further comprises a machine vision system comprising a plurality of image capture devices configured to capture a plurality of images of a real physical environment or a real time video of the real physical environment.

In some embodiments, the machine vision system is part of a drone monitoring system.

In some embodiments, a method comprises simulating a physical environment containing an object, the simulated physical environment corresponding to a real physical environment in which the object is disposed, simulating a camera lens view of the physical environment, the simulated camera lens view corresponding to a view of the real physical environment that would be captured by one or more image capture devices, rendering the camera lens view to obtain a photorealistic view of the physical environment, generating a plurality of simulated images of the physical environment, annotating the plurality of simulated images so as to generate a plurality of annotated images, and generating a data package containing the plurality of annotated images, the plurality of annotated images configured to train an artificial intelligence (AI) system associated with the one or more image capture devices.

In some embodiments, simulating the physical environment includes at least one of: modeling the object and the physical environment, texturing the modeled object and physical environment, and illuminating the modeled object and physical environment corresponding to an illumination of the real physical environment.

In some embodiments, the training of the AI system associated with the one or more image capture devices includes using the plurality of annotated images in conjunction with an automated model to train the AI system associated with one or more image capture devices to identify the objects rendered in the simulated scenes in real life.

In some embodiments, a non-transitory computer-readable media comprising computer-readable instructions stored thereon that when executed by a processor causes the processor to: simulate a physical environment containing an object, the simulated physical environment corresponding to a real physical environment in which the object is disposed, simulate a camera lens view of the physical environment, the simulated camera lens view corresponding to a view of the real physical environment that would be captured by one or more image capture devices, render the camera lens view to obtain a photorealistic view of the physical environment, generate a plurality of simulated images of the physical environment, annotate the plurality of simulated images so as to generate a plurality of annotated images, and generate a data package containing the plurality of annotated images, the plurality of annotated images configured to train an artificial intelligence (AI) system associated with the one or more image capture devices.

In some embodiments, the processor simulates the physical environment by at least one of: modelling the object and the physical environment; texturing the modeled object and physical environment; and illuminating the modeled object and physical environment corresponding to an illumination of the real physical environment. In some embodiments, each of the plurality of simulated images are different from each other. In some embodiments, each of the plurality of simulated images is simulated at a different angle from another one of the plurality of simulated images.

In some embodiments, the processor of the non-transitory computer-readable media utilizes communication between the one or more image capture devices to map a retail facility in order to identify a location of one or more objects within the retail facility.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a block diagram illustrating an example machine learning system that includes an image generation system, and an AI system associated with a machine vision system, according to an embodiment.

FIG. 2 is a schematic block diagram of the image generation system, the AI system, and the machine vision system of FIG. 1, according to an embodiment.

FIG. 3 is a diagram illustrating an embodiment of an example machine vision system that is associated with the AI system of FIG. 1, according to a particular embodiment.

FIG. 4 is an illustration of an example annotated image that is generated by the image generation system of FIG. 1. The annotated image includes a physical environment containing multiple objects, and corresponds to a real image of the physical environment that would be captured by the machine vision system associated with the AI system of FIG. 1.

FIG. 5 is a schematic flow chart of a method for generating a plurality of images for training an AI system, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein generally relate to systems and methods for generating simulated images for training machine learning or AI systems. Particularly, systems and methods described herein relate to an image generation system that is configured to generate a plurality of simulated images that correspond to real images of a physical environment containing an object that would be captured by a machine vision system associated with an AI. The plurality of simulated images are used to train the AI system in lieu of real training images of the physical environment.

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations may be done in the same order of different order and that not all steps are required in every instance.

Conventionally, to train an AI system that is associated with a machine vision system, a user takes a plurality of images of the physical environment that is being captured by the machine vision system, for example, from different angle, in different lighting, etc. These physically captured images are often annotated by users by hand or another tedious manual process, and the annotated images are then used to train the AI system. The image taking and annotating process is however, a tedious process and it can take several hours or even longer to obtain a sufficient number of images that can be used to properly train the AI system to recognize physical objects such that the AI system can reliably recognize objects or features in images taken by the machine vision system during operation.

In contrast, embodiments of the systems and methods described herein may provide one or more benefits including, for example: (1) generating a plurality of simulated images of a real physical environment in lieu of real images of the physical environment that would be captured by a machine vision system for reliably training an AI system associated with the machine vision system; (2) allowing generation of hundreds of simulated images, each of which can be different from each other, in a few minutes, significantly reducing the time involved in capturing real training images that can be several hours or even longer; and (3) allowing annotation of the images during the simulation process, thereby reducing time and cost that would be involved in manually annotating real images after they are captured.

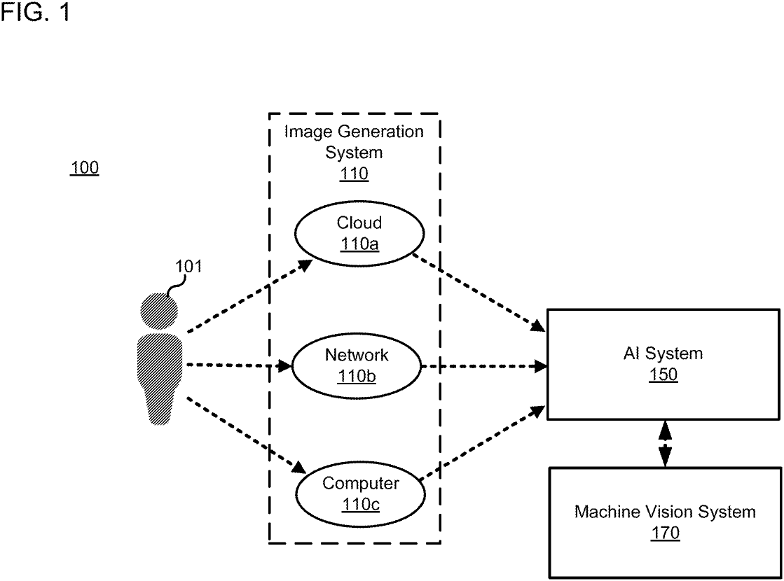

FIG. 1 is a block diagram illustrating an example machine learning system 100 that includes an image generation system 110, and an AI system 150 associated with a machine vision system 170, according to an embodiment. The image generation system 110 is configured to generate a plurality of annotated images for training the AI system 150 so that the AI system 150 can reliably recognize objects in real images captured by the machine vision system 170.

The image generation system 110 may include one or more of a cloud 110a, a network 110b, or a computer 110c (e.g., a main frame, a personal computer, a laptop, a tablet, a mobile phone, etc.) and the like. The image generation system 110 is configured to generate multiple photorealistic 3D or 2D images for training the AI system 150 to enable the AI system can reliably analyze images captured by the machine vision system 170.

Expanding further, the machine vision system 170 may include a plurality of image capture devices (e.g., CCD cameras, optical cameras that may include regular or fish eye lenses, etc.) configured to capture a plurality of images of a real physical environment or a real time video of the real physical environment. Such machine systems can include, for example, machine vision systems for use in retail outlets to capture images of one or more objects (e.g., retail goods) disposed on various shelves of the retail outlet. Particular examples may include image capture devices included in the machine vision system 170 that capture real time images (e.g., 2D or 3D images) and/or video of sides of a bottle in a cooler, all sides of a milk carton in a fridge, all sides of a box on a shelf, etc.

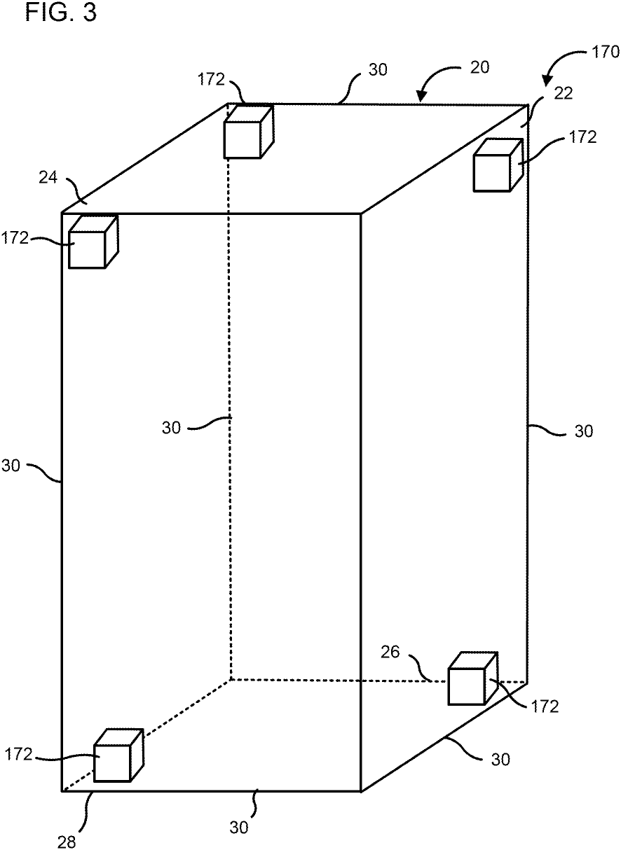

For example, FIG. 3 is a schematic illustration of a particular arrangement of image capture devices 172 that may be included in the machine vision system 170 for a cooler 20. In some embodiments, the machine vision system 170 may be part of a drone monitoring system, for example, those described in U.S. Pat. App. No. 16/846,204, filed Apr. 10, 2020, the entire disclosure of which is hereby incorporated by reference herein. Various embodiments of monitoring drones and systems and methods of operating monitoring drones are also described in PCT Appl. No. PCT/US2018/045664, filed Aug. 7, 2018 and entitled “System, apparatus and method for a monitoring drone,” the entire disclosure of which is hereby incorporated by reference herein. The cooler 20 (e.g., a refrigerator, a vending machine, etc.) may include one or more shelves (not shown) on which one or more objects (not shown) are disposed. The image capture devices 172 may be coupled to the cooler 20 at the top back 22, top front 24, bottom back 26, bottom front 28, any sides 30, or any other suitable location of the cooler 20. It should be appreciated that the particular example of the machine vision system described with respect to the cooler 20 is for illustrative purposes only, and the systems and methods described herein can be used to train any AI system associated with any machine vision system.

The image capture devices 172 shown in FIG. 3 is configured to capture real time images of the real physical environment within the cooler 20 and the number and types of objects contained therein (e.g., different brand soft drink bottles, water bottles, cold coffee bottles, energy drinks, etc.). The parameters of the images or videos captured by the image capture devices 172 depends on various factors, for example, camera angle, camera lens type (e.g., regular vs. a fish eye or wide angle lens), lighting, etc. The AI system 150 is configured to analyze the images or videos of the real physical environment captured by the image capture devices 172 included in the machine vision system 170 and recognize one or more objects contained within the real physical environment. Such information can be used by the AI to determine the number of each object present (e.g., to decide when to place a replenishment order), their current location, their relative location to each other, removal by a user (e.g., to facilitate contact free check out), etc. However, for the AI system 150 to be able to reliably analyze the images captured by the machine vision system 170 and identify objects within the images or videos, the AI system 150 has to be trained on images that are reflective of the images that will be captured by the machine vision system 170 during operation.

To obtain training images for the AI system 150, conventionally, a user 101 would manually capture a plurality of real images of the physical environment (e.g., an interior of the cooler 20), for example, using the image capture devices 172 included in the machine vision system 170, or through a separate camera system which captures images substantially similar to the ones that would be captured by the image capture devices 172. The user 101 may have to adjust the camera angle after each image, adjust the illumination, adjust position of the objects, or any other parameter of the physical environment to recreate various possible scenarios of the physical environment that may be captured by the image capture devices 172 during operation.

Generally, a large number of such manually obtained images (e.g., 50, 60, 70, 80, 90, 100 images, or even more) are used to train the AI system 150 for reliably recognizing the objects that would be included in the physical environment. Manual capture of such real physical images is a tedious process and can take several hours, and in some instances, more than 8 hours to capture a sufficient number of images for training the AI system 150. Moreover, the captured images are generally annotated (e.g., objects within each image marked with identification labels), and the annotations are used by the AI system 150 to identify one or more objects within a captured image, and differentiate various objects from each other. The annotation process is generally, also done manually and this can add a significant amount of time and labor cost to the AI training process.

In contrast, the image generation system 110 is configured to generate any number of simulated images that are photorealistic representations of the real training images that would be captured by the image capture devices 172 and are used for reliably training the AI system 150. The image generation system 110 can generate hundreds or even thousands of images with a generation time for each image of a few seconds, such that the entire training image capture process can be circumvented. Thus, image generation system 110 and labor cost is significantly reduced. Moreover, the image generation system 110 is also configured to annotate the simulated images during image generation, which obviates the manual annotation process and further reduces time and cost for obtaining the training images.

In some embodiments, the image generation system 110 simulates the physical environment containing an object, for example, one or multiple objects. The simulated physical environment corresponds to a real physical environment in which the object is disposed. For example, the image generation system 110 may generate the physical environment of the interior of the cooler 20 that would be captured by the image capture devices 172 of the machine vision system 170. In some embodiments, the user 101 may input a single image of the physical environment into the image generation system 110 that is then used by the image generation system 110 to generate the simulated physical environment. In other embodiments, the user 101 may recreate a representative simulated image in the image generation system 110 and/or input various parameters corresponding to the real physical environment that may be used by the image generation system 110 to generate the simulated physical environment. In some embodiments, the image generation system 110 is configured to simulate the physical environment by modeling the one or more objects and the physical environment (i.e., the surrounding environment in which the one or more objects are disposed), texture the modeled object and physical environment, and/or illuminate the modeled object and physical environment corresponding to an illumination of the real physical environment.

The image generation system 110 may be configured to simulate a camera lens view of the physical environment. The simulated camera lens view corresponds to a view (i.e., a real 2D or 3D image) of the real physical environment that would be captured by the one or more image capture devices 172. For example, with reference to the cooler 20, the real camera lens may be a view captured by the image capture devices 172 of the interior of the cooler 20. This may include a view of one or more shelves (not shown) disposed in the cooler 20 on which a plurality of objects (not shown) are disposed. In particular embodiments, the camera lens view may include a 2D or 3D fish eye view captured by the image capture devices 172. In such embodiments, the simulated camera lens view generated by the image generation system 110 is a fish eye view that replicates a view of the real physical environment that would be captured by the image capture devices 172, i.e., the way the environment would be seen by the image capture devices 172.

The image generation system 110 is configured to render the camera lens view to obtain a photorealistic view of the physical environment. For example, the image generation system 110 may use global illumination to generate the photorealistic image of the physical environment. The photorealistic image may include an image of the background and all the objects contained within the real physical environment.

The image generation system 110 is configured to generate a plurality of simulated images of the physical environment. In some embodiments, each of the plurality of simulated images are different from each other. In particular embodiments, each of the plurality of simulated images is simulated at a different angle from another one of the plurality of simulated images. For example, the image generation system 110 simulates multiple photorealistic view of one or more objects included in the physical environment from different angles, different sides, different illumination, etc. included in the scene. Examples of the plurality of simulated images include, but are not limited to, all sides of bottle in the cooler 20, all sides of a milk carton in a fridge, all sides of a box on a shelf, etc. This can be for a single object in the physical environment, multiple objects, or objects in relation to one another in the physical environment.

In some embodiments, the image generation system 110 may be configured to generate the plurality of simulated images by simulating a video of the photorealistic environment at a predetermined frames per second (FPS) rate (e.g., 30, 60, 90, 120, 240 FPS or an even higher rate). For example, the video may start from a first photorealistic view of the object contained in the physical environment, and the view may then pan around the object to generate the plurality of views of the object from various angles. Illumination, scenery (i.e., the surroundings of the one or more objects) and/or other parameters of the photorealistic image may also be adjusted in the video sequence. Depending on the predetermined FPS rate, hundreds or even thousands of image can be generated for training the AI system 150, with an average time for generating each image being a few seconds (e.g., less than 5 seconds per image).

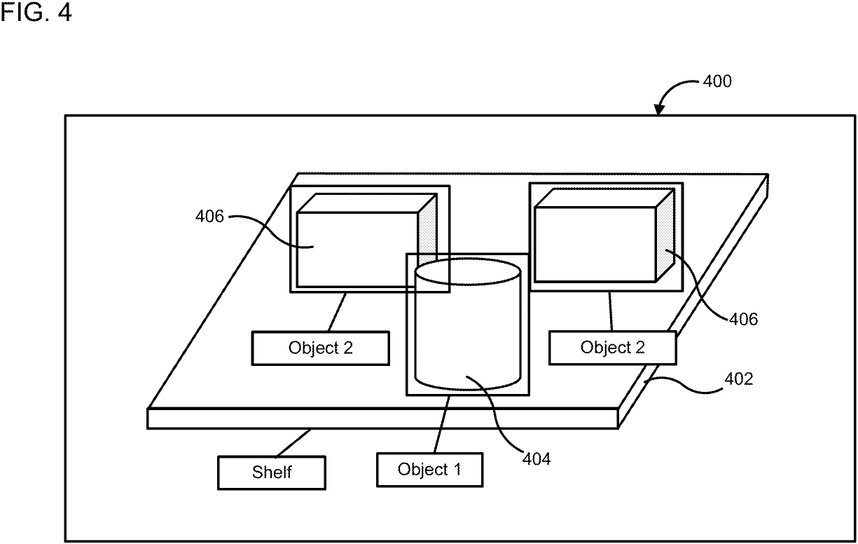

The image generation system 110 annotates the plurality of simulated images so as to generate a plurality of annotated images. In some embodiments, the image generation system 110 may annotate the simulated images by tagging one or each of the objects included in the simulated image of the physical environment with identification numbers. For example, FIG. 4 shows an illustration of an example annotated image 400 of a physical environment generated by the image generation system 110. The image includes a shelf 402 on which a first object 404 and a pair of second objects 406 are disposed behind the first object 404. The image generation system 110 tags each of the shelf 402, the first object 404, and the second objects 406 with identification numbers, for example, shelf, object 1, and object 2, respectively, by generating labeled boxes around each object. However, any other form of annotation or otherwise identification tag may be used. In some embodiments, the image generation system 110 may annotate the images before generating the plurality of simulated images or simultaneously while generating the simulated images. This advantageously obviates the need to annotate real physical training images after they are captured when training images are generated conventionally. In some embodiments, the image generation system 110 annotates the objects and recognizes the related 3 dimensional position of each object relative to another object in the image, i.e., their relative x, y, z position (e.g.., the position of object 1 and objects 2 relative to each other in FIG. 4). As such, the image generation system 110 automatically creates and annotates objects in the simulated scene.

The image generation system 110 generates a data package containing the plurality of annotated images that are configured to train the AI system 150 associated with the one or more image capture devices 172. In some embodiments, the image generation system 110 may include, or be communicatively coupled to the network 110b (e.g., a communication network) that transmits the data package to the AI system 150. The network 110b may include any suitable Local Area Network (LAN) or Wide Area Network (WAN). For example, the network 110b can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The network 110b is structured to permit the exchange of data, values, instructions, messages, and the like between the image generation system 110 and the AI system 150. In other embodiments, the AI system 150 may be included in, or be a part of the image generation system 110. The AI system 150 uses the plurality of annotated images to train for identifying the one or more objects located in the real physical environment from real images captured by the image capture devices 172 of the machine vision system 170.

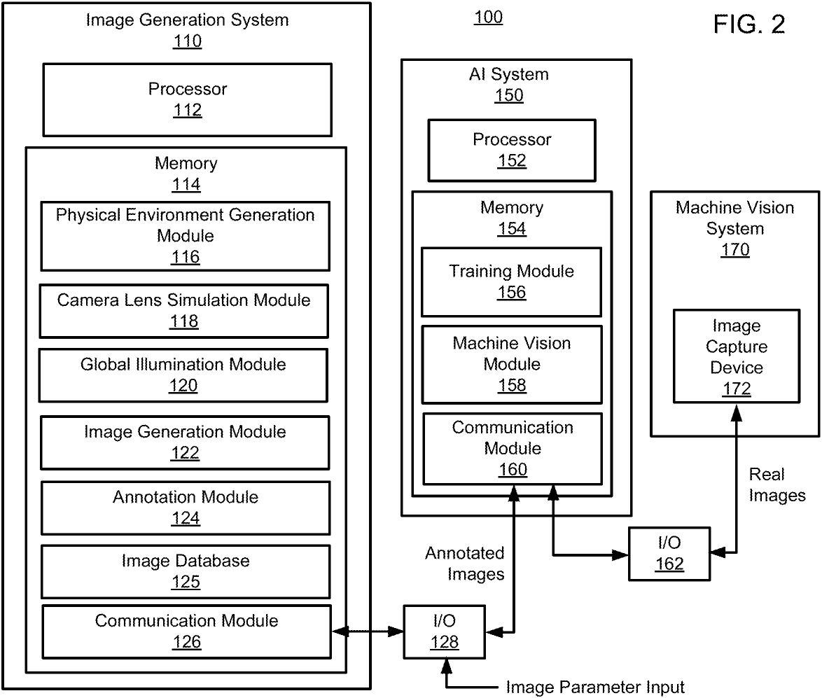

FIG. 2 is a schematic block diagram of the image generation system 110, the AI system 150, and the machine vision system 170 of FIG. 1, according to an embodiment. The image generation system 110 may include a processor 112, a memory 114, a physical environment generation module 116, a camera lens view generation module 118, a global illumination module 120, an image generation module 122, an annotation module 124, an image database 125, and a communication module 126.

The processor 112 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components.

The memory 114 stores data and/or computer code for facilitating at least some of the various processes described herein. The memory 114 includes tangible, non-transient volatile memory, or non-volatile memory. The memory 114 may include a non-transitory processor readable medium having stores programming logic that, when executed by the processor 112, controls the operations of the image generation system 110. Memory 114 may be any combination of one or more computer readable media. The computer readable media may be a computer readable signal medium, any type of memory or a computer readable non-transitory storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium may include, but are not limited to: a portable computer diskette, a hard disk, a random access memory (“RAM”), a read-only memory (“ROM”), a Non-volatile RAM (NVRAM), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device. In some arrangements, the processor 112 and the memory 114 form various processing circuits or modules described with respect to the image generation system 110 (e.g., the physical environment generation module 116, the camera lens view generation module 118, the global illumination module 120, the image generation module 122, and the annotation module 124).

Computer program code for carrying out operations utilizing a processor or CPU 112 for aspects of the present disclosure may be written in any combination of one or more programming languages, markup languages, style sheets and JavaScript libraries, including but not limited to Windows Presentation Foundation (WPF), HTML/CSS, Node, XAML, and JQuery, C, Basic, *Ada, Python, C++, C#, Pascal, *Arduino, JAVA and the likes. Additionally, operations can be carried out using any variety of compiler available.

The computer program instructions on memory 114 may be provided to the processor 112, where the processor 112 is of a general purpose computer, special purpose computer, microchip or any other programmable data processing apparatus to produce a machine, such that the instructions, which execute via the processor of the computer or other programmable instruction execution apparatus, create a mechanism for implementing the functions/acts specified in the flowchart and/or block diagram block or blocks. The computer instructions may do one or more of the following - model the physical environment, model the objects, generate the photorealistic physical images of the real physical environment, annotate the images, and generate the data package including the annotated images that is transmitted to the AI system 150. The processor 112 is configured to control operations of the image generation system 110, for example, configured to execute instructions stored in the memory 114, or stored in the various modules.

These computer program instructions may also be stored in the memory 114 (computer readable medium) that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The physical environment generation module 116 is configured to simulate the physical environment containing an object, as described herein. The physical environment generation module 116 simulates the physical environment by modeling the object and the physical environment, texturing the modeled object and physical environment, and/or illuminating the modeled object and physical environment corresponding to an illumination of the real physical environment.

In some embodiments, the physical environment generation module 116 may receive image parameters from an input/output (I/O) circuit 128 for generating the physical environment containing the one or more objections. The I/O circuit 128 may also be configured to receive user input from and provide information to the user 101. In this regard, the I/O circuit 128 is structured to exchange data, communications, instructions, etc. with an input/output component of the image generation system 110 and the AI system 150. Accordingly, in some arrangements, the I/O circuit 128 includes an input/output device such as a display device, touchscreen, keyboard, microphone, a finger print reader, and/or the like. In some arrangements, the I/O circuit 128 includes communication circuitry for facilitating the exchange of data, values, messages, and the like between the input/output device and the components of the image generation system 110. In still another arrangement, the I/O circuit 128 includes any combination of hardware components (e.g., a touchscreen), communication circuitry, and machine-readable media.

The camera lens view generation module 118 is configured to simulate a camera lens view of the physical environment, which corresponds to a view of the real physical environment that would be captured by the one or more image capture devices 172. In some embodiments in which the image capture devices 172 include fish eye lenses or wide angle lenses, the simulated camera lens view also includes a fish lens or wide angle view of the physical environment.

The global illumination module 120 is configured to render the camera lens view to obtain a photorealistic view of the physical environment. The image generation module 122 is configured to generate a plurality of simulated images of the physical environment. Each of the plurality of simulated images are different from each other, for example, is simulated at a different angle from another one of the plurality of simulated images.

The annotation module 124 is configured to annotate the plurality of simulated images so as to generate a plurality of annotated images, as previously described herein. The image database 125 is configured to store the plurality of annotated images generated by the annotation module 124.

As shown, the image generation system includes the communication module 126. The communication module 126 is structured for sending and receiving data from the AI system 150, the I/O circuit 128, computers, networks, cloud, and the likes. In some embodiments, the communication module 126 may include Ethernet, USB connection, port connections of various types, wireless, combination thereof and the likes. In some embodiments, the communication module 126 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like. The communication module 126 may communicate in real-time, in intervals, on demand or a combination there of. The communication module 126 is configured to generate a data package containing the plurality of annotated images that are communicated via the I/O circuit 128 to the AI system 150, which are configured to train the AI system 150.

The AI system 150 may include an AI system process 152, an AI system memory 154, an AI system training module 156, an AI system machine vision module 158, and an AI system communication module 160. The AI system training module 156 is configured to train the AI system 150 for recognizing objects in an image captured by the image capture devices 172 of the machine vision system 170. The AI system training module 156 receives the plurality of annotated images contained in the data package that is communicated to the AI system communication module 160 from the communication module 126 and uses the plurality of annotated images to train for identifying the object located in the real physical environment based on real images captured by the one or more image capture devices 172. For example, the AI system 150 may use the annotated images in conjunction with an automated model for training and to identify the objects rendered in the simulated scenes in real life. As a result, the process for modeling is exponentially faster and reduces bias results. The AI system machine vision module 158 is configured to receive real images captured by the image capture devices 172 of the machine vision system 170 via an AI system I/O circuit 162 and interpret the images to identify one or more objects contained in the images.

While the machine vision system 170 is shown as including a single image capture device 172, the machine vision system 170 may include a plurality of image capture devices 172. The image capture device 172 may be one or more of the following a mono-camera, a stereo camera, a video camera, an infrared camera, a Realsense camera, Kinect Camera, Leap camera, a depth camera, a color camera, structured light camera, a combination thereof, and the likes. In one embodiment, multiple image capture devices 172 are used in a configuration where the image capture devices 172 may be angled in one or more angle to capture different views. In another embodiment, the multiple image capture devices 172 may communicate with each other to learn location in relation to one another. For example, the image capture device 172 may communicate with another image capture device 172 on both sides off the shelf or isle. Such communication is utilized for mapping of a facility or room using depth, such as, a store, distribution center, etc. As such, the machine vision system 170 may be utilized for determining where objects, such as, goods, inventory, individuals, are located within the such a facility. Hence, such a configuration may be used by third parties to determine arrival of items to a facility and to confirm placement. For example, a chips stand-alone cardboard can be remotely verified to confirm arrival, installation and/or location within a store, etc.

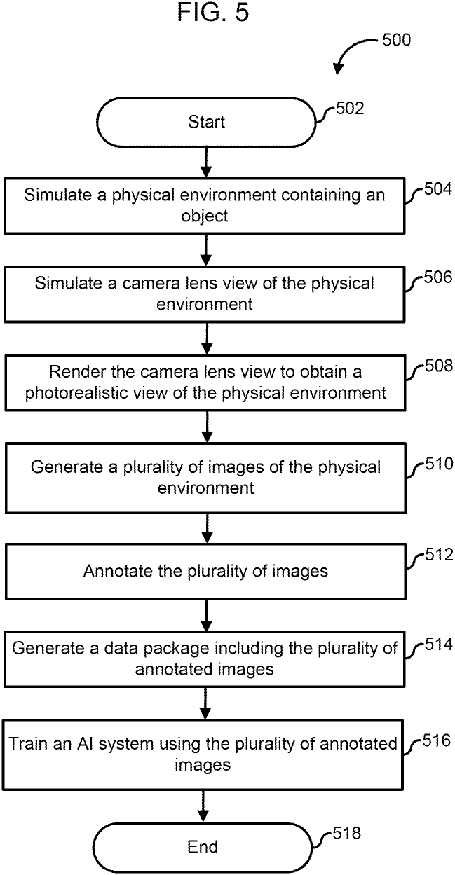

FIG. 5 is a schematic flow chart of a method 500 for generating a plurality of images for training the AI system 150, according to an embodiment. While the method 500 is described with respect to the image generation system 110 and the AI system 150, it should be appreciated that the operations of the method 400 may be implemented with any image generation system for generating images for training any AI system.

The method 500 starts at 502, and at 504, the processor 112 of the image generation system 110 simulates a physical environment containing an object (e.g., the object 1, object 2, or any other number of objects). The simulated physical environment corresponds to a real physical environment in which the object is disposed. The processor 112 may simulate the physical environment by modeling the object and the physical environment, texturing the modeled object and physical environment, and/or illuminating the modeled object and physical environment corresponding to an illumination of the real physical environment.

At 506, the method 500 includes simulating, by the processor 112, a camera lens view of the physical environment, which corresponds to a view of the real physical environment that would be captured by the one or more image capture devices 172. At 508, the method 500 includes rendering, by the processor 112, the camera lens view to obtain a photorealistic view of the physical environment. At 510, the processor 112 generates a plurality of simulated images of the physical environment. The plurality of images may be different from each other, for example, each of the plurality of simulated images is simulated at a different angle from another one of the plurality of simulated images. At 512, the processor 112 annotates the plurality of simulated images to generate a plurality of annotated images. At 514, the processor 112 generates a data package contain the plurality of images. The data package is communicated to the AI system 150, and the AI system 150 is trained using the plurality of annotated images, at 516, and the method 500 ends, at 518.

In some embodiments, an image generation system, comprises: a memory; and a processor configured to: simulate a physical environment containing an object, the simulated physical environment corresponds to a real physical environment in which the object is disposed. The processor is configured to simulate a camera lens view of the physical environment, the simulated camera lens view corresponding to a view of the real physical environment that would be captured by one or more image capture devices. The processor is configured to render the camera lens view to obtain a photorealistic view of the physical environment. The processor is configured to generate a plurality of simulated images of the physical environment, annotate the plurality of simulated images so as to generate a plurality of annotated images, and generate a data package containing the plurality of annotated images, the plurality of annotated images configured to train an AI system associated with the one or more image capture devices.

In some embodiments, the processor simulates the physical environment by at least one of: modelling the object and the physical environment; texturing the modeled object and physical environment; and illuminating the modeled object and physical environment corresponding to an illumination of the real physical environment. In some embodiments, each of the plurality of simulated images are different from each other. In some embodiments, each of the plurality of simulated images is simulated at a different angle from another one of the plurality of simulated images.

In some embodiments, a machine learning system, comprises: the image generation system as described above; and the AI system. The AI system comprises: an AI system memory; and an AI system processor configured to: receive the data package from the image generation system, and use the plurality of annotated images to train for identifying the object located in the real physical environment based on real images captured by the one or more image.

It should be noted that the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples). The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “module” may include hardware structured to execute the functions described herein. In some arrangements, each respective “module” may include machine-readable media for configuring the hardware to execute the functions described herein. The module may be embodied as one or more circuitry components including, but not limited to, processing circuitry, network interfaces, peripheral devices, input devices, output devices, sensors, etc. In some arrangements, a module may take the form of one or more analog circuits, electronic circuits (e.g., integrated circuits (IC), discrete circuits, system on a chip (SOCs) circuits, etc.), telecommunication circuits, hybrid circuits, and any other type of “module.” In this regard, the “module” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “module” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “module” as described herein may include components that are distributed across one or more locations.

An exemplary system for implementing the overall system or portions of the arrangements and embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick, touch sensitive screen or other input devices performing a similar function. Comparatively, the term “output device,” as described herein, may include any type of output device including, but not limited to, a computer monitor, printer, facsimile machine, a LAN card or WiFi® transmission circuit for data transmission or other output devices performing a similar function

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and

While this specification contains many specific implementation details, these should not be construed as limitations on the scope of any arrangement or of what may be claimed, but rather as descriptions of features specific to particular implementations of particular arrangements. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An image generation system, comprising:
a memory; and
a processor configured to:
simulate a physical environment containing an object, the simulated physical environment corresponding to a real physical environment in which the object is disposed,
simulate a camera lens view of the physical environment, the simulated camera lens view corresponding to a view of the real physical environment that would be captured by one or more image capture devices,
render the camera lens view to obtain a photorealistic view of the physical environment,
generate a plurality of simulated images of the physical environment,
annotate the plurality of simulated images so as to generate a plurality of annotated images, and
generate a data package containing the plurality of annotated images, the plurality of annotated images configured to train an artificial intelligence (AI) system associated with the one or more image capture devices.

2. The image generation system of claim 1, wherein the processor simulates the physical environment by at least one of:
modelling the object and the physical environment;
texturing the modeled object and physical environment; and
illuminating the modeled object and physical environment corresponding to an illumination of the real physical environment.

3. The image generation system of claim 2, wherein the training of the AI system associated with the one or more image capture devices comprises using the plurality of annotated images in conjunction with an automated model to train the AI system associated with one or more image capture devices to identify the objects rendered in the simulated scenes in real life.

4. The image generation system of claim 1, wherein each of the plurality of simulated images are different from each other.

5. The image generation system of claim 4, wherein the each of the plurality of simulated images is simulated at a different angle from another one of the plurality of simulated images.

6. The image generation system of claim 1, wherein the processor is configured to utilize communication between the one or more image capture devices to map a retail facility in order to identify a location of one or more objects within the retail facility.

7. A machine learning system, comprising:
the image generation system of claim 1; and
the AI system, wherein the AI system comprises:
an AI system memory; and
an AI system processor configured to:
receive the data package from the image generation system, and
use the plurality of annotated images to train for identifying the object located in the real physical environment based on real images captured by the one or more image capture devices.

8. The machine learning system of claim 7, wherein the machine learning system further comprises a machine vision system comprising a plurality of image capture devices configured to capture a plurality of images of a real physical environment or a real time video of the real physical environment.

9. The machine learning system of claim 8, wherein the machine vision system is part of a drone monitoring system.

10. A method comprising:
simulating a physical environment containing an object, the simulated physical environment corresponding to a real physical environment in which the object is disposed;
simulating a camera lens view of the physical environment, the simulated camera lens view corresponding to a view of the real physical environment that would be captured by one or more image capture devices;
rendering the camera lens view to obtain a photorealistic view of the physical environment;
generating a plurality of simulated images of the physical environment;
annotating the plurality of simulated images so as to generate a plurality of annotated images; and
generating a data package containing the plurality of annotated images, the plurality of annotated images configured to train an artificial intelligence (AI) system associated with the one or more image capture devices.

11. The method of claim 10, wherein simulating the physical environment includes at least one of:
modeling the object and the physical environment;
texturing the modeled object and physical environment; and
illuminating the modeled object and physical environment corresponding to an illumination of the real physical environment.

12. The method of claim 11, wherein the training of the AI system associated with the one or more image capture devices comprises using the plurality of annotated images in conjunction with an automated model to train the AI system associated with one or more image capture devices to identify the objects rendered in the simulated scenes in real life.

13. The method of claim 10, wherein each of the plurality of simulated images are different from each other.

14. The method of claim 13, wherein each of the plurality of simulated images is simulated at a different angle from another one of the plurality of simulated images.

15. A non-transitory computer-readable media comprising computer-readable instructions stored thereon that, when executed by a processor, causes the processor to:
simulate a physical environment containing an object, the simulated physical environment corresponding to a real physical environment in which the object is disposed;
simulate a camera lens view of the physical environment, the simulated camera lens view corresponding to a view of the real physical environment that would be captured by one or more image capture devices;
render the camera lens view to obtain a photorealistic view of the physical environment;
generate a plurality of simulated images of the physical environment;
annotate the plurality of simulated images so as to generate a plurality of annotated images; and
generate a data package containing the plurality of annotated images, the plurality of annotated images configured to train an artificial intelligence (AI) system associated with the one or more image capture devices.

16. The non-transitory computer readable media of claim 15, wherein the processor simulates the physical environment by at least one of:
modelling the object and the physical environment;
texturing the modeled object and physical environment; and
illuminating the modeled object and physical environment corresponding to an illumination of the real physical environment.

17. The non-transitory computer readable media of claim 15, wherein the training of the AI system associated with the one or more image capture devices comprises using the plurality of annotated images in conjunction with an automated model to train the AI system associated with one or more image capture devices to identify the objects rendered in the simulated scenes in real life.

18. The non-transitory computer readable media of claim 15, wherein each of the plurality of simulated images are different from each other.

19. The non-transitory computer readable media of claim 18, wherein each of the plurality of simulated images is simulated at a different angle from another one of the plurality of simulated images.

20. The non-transitory computer readable media of claim 15, wherein the processor utilizes communication between the one or more image capture devices to map a retail facility in order to identify a location of one or more objects within the retail facility.
